(19) United States
(12) Patent Application Publication
(10) Pub. No.: US 2026/0139800 A1
(43) Pub. Date: May 21, 2026

(54) STORAGE DEVICE, METHOD FOR ESTIMATING THE TEMPERATURE AND/OR FOR COMMANDING A HALT IN THE FILLING OF SUCH A DEVICE

(71) Applicant: L'Air Liquide, Société Anonyme pour I'Etude et I'Exploitation des Procédés Georges Claude, Paris (FR)

(72) Inventors: Remi GONIN, Jouy-en-Josas (FR); Fouad AMMOURI, Massy (FR); Elena VYAZMINA, Paris (FR); David VEMPAIRE, Sassenage (FR)

(21) Appl. No.: 19/375,810

(22) Filed: Oct. 31, 2025

(51) Int. Cl. F17C 13/02; F17C 5/00

(52) U.S. Cl. CPC F17C 13/026; F17C 5/007; F17C 13/025; F17C 2221/012; F17C 2250/032; F17C 2250/043; F17C 2250/0439; F17C 2250/0636; F17C 2250/0694; F17C 2270/0168; F17C 2270/0184

(57) ABSTRACT

An on-board device for storing pressurized gas, for example hydrogen. The device includes a tank, a sensor for measuring the pressure of the gas in the tank, a first sensor for measuring the ambient temperature, a computer having an electronic system equipped with a microprocessor for acquiring and processing data. In particular, the computer is configured to: i) receive and process measurements from the sensors, and ii) calculate a theoretical minimum temperature and a theoretical maximum temperature of the gas in the tank on the basis of the measurements from the sensors and by using at least one predefined predictive model, the computer also being configured to approximate the temperature of the gas in the tank to a value of between the theoretical minimum temperature and the theoretical maximum temperature, or to a value equal to one of either the theoretical minimum temperature or the theoretical maximum temperature.

### BACKGROUND

The invention relates to a device for storing pressurized gas, comprising a tank and a computer for estimating the temperature of the gas in the tank. The invention also relates to a method for estimating the temperature of the gas in such a storage device. The invention finally relates to a method for commanding a halt in the filling of such a storage device.

The gas considered in the context of the present invention may be hydrogen.

The tank of the storage device may be that of a fuel cell vehicle (FCV). The tank may be in the process of being filled from a gas dispensing station, in the process of being emptied or drawn from, or in a stable state, namely not being filled or emptied.

When filling or drawing from a pressurized gas tank, it is necessary to estimate the mass and the mean temperature of the gas in the tank in order to guarantee the physical integrity of said tank. Specifically, overfilling can lead to overheating of the gas, whereas continuous withdrawal can lead to the temperature of the gas falling below a certain threshold known as the critical cold threshold.

Standard SAE J2601 recommends that the gas temperature be maintained between a maximum threshold, set at 85° C. and a minimum threshold, set at −40° C. (for tanks made of composite material). Similarly, standard SAE J2601 recommends maintaining the density below a certain threshold for a certain nominal operating pressure.

In order to protect the tank from the risk of overheating or of critical cold, there is a known method which involves measuring the temperature of the gas using a temperature sensor placed in the tank itself. Such a measurement is generally far from representative of the mean temperature in the tank.

Also known, from document WO 2024/017677 A1, is a method that envisages estimating the temperature and/or the density of the gas in a tank using means installed at the dispensing station.

This method therefore remains dependent on the dispensing station, and cannot be implemented when the tank is not being supplied by the dispensing station, notably when the vehicle fitted with the tank is in motion, or when the estimation means installed at the station are out of service.

It should be noted that in order to estimate the temperature of the gas in a tank, a dispensing station must first acquire data relating to geometric parameters of the tank and/or data relating to thermo-physical parameters of the gas in the tank. These data may be communicated to the dispensing station by a communication means coupled to the tank.

In some cases, these data are not communicated to the dispensing station and are therefore estimated by the latter on the basis of a number of conservative assumptions. It then follows that the temperature of the gas in the tank, as estimated by the dispensing station, is less accurate.

In view of the drawbacks listed above, it appears necessary to develop a solution allowing the mean temperature of the tank to be estimated even when the latter is not connected to a dispensing station.

### SUMMARY

To this end, a first aspect of the invention introduces an on-board storage device.

The storage device comprises a tank, a sensor for measuring the pressure of the gas in the tank, a first sensor for measuring the ambient temperature, a computer comprising an electronic system equipped with a microprocessor for acquiring and processing data.

In particular, the computer is configured to receive and process measurements from the pressure sensor and from the first temperature sensor. Furthermore, the computer is configured to calculate a theoretical minimum temperature and a theoretical maximum temperature of the gas in the tank on the basis of the measurements from said sensors and by using at least one predefined predictive model. Finally, the computer is configured to approximate the temperature of the gas in the tank to a value comprised between the theoretical minimum temperature and the theoretical maximum temperature, or to a value equal to one of either the theoretical minimum temperature or the theoretical maximum temperature.

In otherwords, the starting point of the invention is an existing tank equipped with an internal-pressure sensor and an external-temperature sensor. The invention combines a computer with this subassembly to form an on-board storage device.

Thanks to the tank sensors, and to the computer associated with this tank within the on-board storage device, the temperature of the gas in the tank can be estimated at any time, without recourse to a means external to the on-board storage device and that would require mechanical coupling with the tank for the purpose of transmitting or receiving a signal from the tank.

Thus, the temperature of the gas in the tank can be estimated even when the tank is not coupled to a dispensing station, particularly when the tank is in the process of being emptied. Similarly, the temperature of the gas in the tank can be estimated even in the event of failure of estimation means installed at the dispensing station.

In instances in which the tank is connected to a dispensing station and the latter is able to estimate the temperature of the gas in the former, the fact that a computer, a pressure sensor and a temperature sensor are available, all connected to the tank within the on-board device, provides redundancy in estimating the temperature of the gas in the tank.

Thus, the invention opens up the possibility of having a double safety barrier when estimating the temperature of the gas in the tank.

Finally, by virtue of the presence of the computer associated with the tank within the on-board storage device, data relating to geometric parameters of the tank and/or data relating to thermophysical properties of the gas present in the tank is at all times available to the computer. Thus, the estimate of the temperature of the gas in the tank is more accurate.

Moreover, embodiments of this first aspect of the invention may comprise one or more of the following features:
the theoretical minimum temperature and the theoretical maximum temperature are respectively determined with the aid of a first predictive curve “TPgas_hot” and a second predictive curve “TPgas_cold”, each dependent on the pressure of the gas in the tank, as measured by the first pressure sensor, and on the ambient temperature outside the tank, as measured by the first temperature sensor,
the device further comprises a second sensor for measuring the temperature of the gas in the tank,
the second temperature sensor is configured to provide a first initial temperature and a second initial temperature respectively representing the starting conditions of the first predictive curve “TPgas_hot” and the starting conditions of the second predictive curve “TPgas_cold”,
the first initial temperature and the second initial temperature are respectively equal to the highest and lowest temperatures measured by the second temperature sensor,
the gas temperature determined by the computer is equal to the theoretical minimum temperature, in the event of overfilling of the tank, i.e. when the state of charge of the tank is greater than 1,
the gas temperature determined by the computer is equal to the theoretical maximum temperature, in the event of overheating, i.e. when the theoretical maximum temperature reaches a predetermined critical threshold,
the gas temperature determined by the computer is equal to the lowest of i) the temperature measured by the second temperature sensor and ii) the theoretical minimum temperature, in the event of overfilling of the tank, i.e. when the state of charge of the tank is greater than 1, or
the gas temperature determined by the computer is equal to the highest of i) the temperature measured by the second temperature sensor and ii) the theoretical maximum temperature, in the event of overheating of the tank, i.e. when a predefined maximum temperature threshold is reached,
the device comprises an injector positioned at the inlet to the tank,
the injector is intended to connect the tank to a dispensing station,
the computer is configured to calculate a first injection temperature at the tank inlet, on the basis of a gas temperature and pressure measured at the dispensing station,
the first predictive curve “TPgas_hot” and the second predictive curve “TPgas_cold” are also each dependent on the first injection temperature,
the injector is provided with a third temperature sensor configured to measure a second injection temperature of the gas at the inlet of the tank, and communicate said second injection temperature to the computer,
the first predictive curve “TPgas_hot” and the second predictive curve “TPgas_cold” are also each dependent on the second injection temperature,
the computer is configured to send the dispensing station an order to halt the filling, on the basis of an approximation of the temperature of the gas in the tank,
the on-board device comprises a shut-off valve for halting the filling of the tank,
the computer is configured to command a closing of the shut-off valve, on the basis of an approximation of the temperature of the gas in the tank.

A second aspect of the invention relates to a method for estimating, in real-time, the temperature of a gas in an on-board pressurized-gas storage device.

The device comprises a tank, a pressure sensor, a first temperature sensor, a computer comprising an electronic system equipped with a microprocessor for acquiring and processing data.

The method comprises a step of measuring the pressure of the gas in the tank, using the pressure sensor, a step of measuring the ambient temperature outside the tank, using the first temperature sensor, a step executed by the computer on the basis of at least one predefined predictive model, for determining a theoretical minimum temperature and a theoretical maximum temperature of the gas in the tank, and a step, executed by the computer, for approximating the temperature of the gas in the tank to a value comprised between the theoretical minimum temperature and the theoretical maximum temperature, or to a value equal to one of either the theoretical minimum temperature or the theoretical maximum temperature.

Moreover, embodiments of this first aspect of the invention may comprise one or more of the following features:
the theoretical minimum temperature and the theoretical maximum temperature are respectively calculated with the aid of a first predictive curve “TPgas_hot” and of a second predictive curve “TPgas_cold”, each dependent on the pressure of the gas in the tank, as measured by the pressure sensor, and on the ambient temperature outside the tank, as measured by the first temperature sensor,
the method comprises a step of determining a first initial temperature and a second initial temperature respectively representing the starting conditions of the first predictive curve “TPgas_hot” and the starting conditions of the second predictive curve “TPgas_cold”,
the first initial temperature corresponds to a first state of the tank, considered to have been recently filled to a first initial density,
the second initial temperature corresponds to a second state of the tank, that is considered to have been recently drawn from down to a second initial density,
the first initial temperature and the second initial temperature are obtained respectively from a first theoretical curve “ThotSoak” and a second theoretical curve “TcoldSoak”, each giving a variation in the temperature of the gas in a first reference tank as a function of the ambient temperature,
the first theoretical curve “ThotSoak” relates to the first reference tank in the process of being filled,
the second theoretical curve “TcoldSoak” relates to the second reference tank in the process of being emptied,
the first initial temperature is comprised within a range of high temperatures having a determined lower limit that is greater than or equal to the ambient temperature and a determined upper limit that corresponds to a fixed maximum temperature, for example equal to 85° C.,
the second initial temperature is comprised within a range of low temperatures having a determined upper limit that is less than or equal to the ambient temperature and a determined lower limit that corresponds to a fixed minimum, for example comprised between zero and −40° C.,
the first initial temperature and the second initial temperature are measured using a second temperature sensor disposed in the tank,
the first initial temperature and the second initial temperature are respectively equal to the highest and lowest temperatures measured by the second temperature sensor,
the first initial temperature and the second initial temperature are temperatures obtained during the course of a previous cycle of steps of the method for estimating the temperature of the gas in the on-board device,
the first initial temperature and the second initial temperature are respectively equal to the highest and lowest temperatures estimated during the course of the previous cycle of steps of the method for estimating the temperature of the gas in the on-board device,
the method comprises a step of acquisition, by the computer, of data relating to geometric parameters of the tank, and of data relating to thermophysical properties of the gas present in the tank,
the predictive curves “TPgas_hot” and “TPgas_cold” are further dependent on each of the geometric parameters of the tank and the thermophysical properties of the gas present in the tank,
the method comprises a step of determining at least one injection temperature of the gas entering the tank,
the predictive curves “TPgas_hot” and “TPgas_cold” are each further dependent on the injection temperature of the gas entering the tank,
the step of determining the injection temperature or temperatures of the gas entering the tank comprises a first operation of calculating a first injection temperature using a function that is dependent on: i) the ambient temperature measured outside the tank, ii) the gas temperature measured at the dispensing station, and iii) the gas pressure measured at the dispensing station,
the step of determining the injection temperature or temperatures of the gas entering the tank comprises a second operation of measuring a second gas-injection temperature, using a third temperature sensor situated at an injector located at the inlet of the tank,
the injection temperature taken into consideration in, respectively, the first predictive curve “TPgas_hot” and the second predictive curve “TPgas_cold” is the highest and, respectively, the lowest, temperature of the first injection temperature obtained during the course of the first calculation operation and the second injection temperature obtained during the course of the second measurement operation,
the first predictive curve “TPgas_hot” and the second predictive curve “TPgas_cold” are obtained from a physical model that simulates the filling or emptying of a second reference tank,
the physical model is based on a system of equations comprising at least one of: i) an internal energy balance equation applied to the gas in the tank, ii) a mass balance equation applied to the gas in the tank, iii) an energy conservation equation relating to a wall of the tank, iv) an equation of continuity of heat flux between the gas in the tank and the wall of the tank, v) an equation of continuity of heat flux between the wall of the tank and the ambient air, and vi) a flow rate equation connecting a mass flow rate of the filling device to a pressure difference between the filling device and the tank.

A third aspect of the invention relates to a method for commanding a halt in the filling of an on-board device for storing pressurized gas, for example hydrogen.

The device comprises a tank, a sensor for measuring the pressure of the gas in the tank, a first sensor for measuring the ambient temperature, a computer comprising an electronic system equipped with a microprocessor for acquiring and processing data.

In particular, the computer is configured to calculate a theoretical minimum temperature and a theoretical maximum temperature of the gas in the tank on the basis of the pressure of the gas in the tank and of the ambient temperature, and by using at least one predefined predictive model. Furthermore, the computer is configured to approximate the temperature of the gas in the tank to a value comprised between the theoretical minimum temperature and the theoretical maximum temperature, or to a value equal to one of either the theoretical minimum temperature or the theoretical maximum temperature.

The method comprises a step of issuing an order to halt the filling of the tank on the basis of the gas temperature approximated by the computer.

The invention may also relate to any alternative device or method comprising any combination of the features above or below within the scope of the claims.

### BRIEF DESCRIPTION OF THE DRAWINGS

Further specific features and advantages will become apparent upon reading the description below, which is provided with reference to the following figures, in which:

FIG. 1 is a schematic view in cross section of one example of an on-board storage device according to the invention, the device comprising a tank and a computer.

FIG. 2 schematically illustrates steps of a method for estimating the temperature of the on-board storage device of FIG. 1;

FIG. 3 illustrates two curves giving the variation in the temperature of the gas in a reference tank as a function of the ambient temperature: a first curve defined over a range of high temperatures and a second curve defined over a range of low temperatures.

FIG. 4 illustrates curves each giving the variation in the temperature of the gas in a tank that is in the process of being filled, the tank being considered as having been recently filled (first curve) or as having been recently drawn from (second curve).

### DETAILED DESCRIPTION OF THE PREFERRED EMBODIMENTS

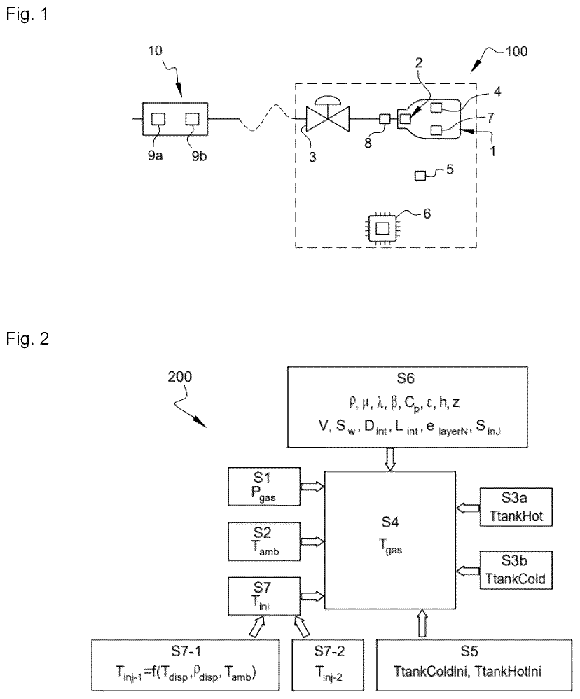

With reference to FIG. 1, the invention relates to an on-board device 100 for storing a pressurized gas.

The on-board device 100 comprises a pressurized-gas tank 1, and a module for estimating the temperature Tgas of the gas in the tank 1. The on-board device 100 may also comprise a shut-off valve 3 and a flowmeter (not illustrated) at the inlet of the tank 1.

In particular, the tank 1 may be equipped with an injector 2. Furthermore, the tank 1 may consist of several containers connected to each other. Finally, the tank 1 may be that of a fuel cell vehicle or any other type of means of transport.

Thus, the tank 1 may be in the process of being filled from a dispensing station 10, in the process of being emptied when the vehicle on board which the tank 1 is fitted is in motion, or in a stable state, when the tank 1 is in neither of the aforesaid configurations.

The estimation module comprises a first pressure sensor 4 positioned inside the tank 1 and configured to measure the pressure Pgas of the gas in the tank 1. The estimation module also comprises a first temperature sensor 5, located outside the tank 1 and configured to measure the ambient temperature Tamb. Finally, the estimation module comprises a computer 6 which consists of an electronic system in communication with the pressure sensor 4 and the first temperature sensor 5.

Advantageously, the estimation module may comprise a second temperature sensor 7 disposed inside the tank 1, and a third temperature sensor 8 disposed at the inlet of the tank 1. The second temperature sensor 7 and the third temperature sensor 8 are configured to communicate with the computer 6.

It should be noted that the shut-off valve 3, the third temperature sensor 8 and the flowmeter may be positioned at the injector 2 situated in the tank 1.

The computer 6 is configured to determine a theoretical minimum temperature TtankCold and a theoretical maximum temperature TtankHot of the gas in the tank 1, using at least one predefined predictive model that takes account of the gas pressure Pgas measured by the pressure sensor 4, and of the ambient temperature Tamb measured by the first temperature sensor 5.

The computer 6 is also configured to approximate the temperature Tgas of the gas in the tank 1 to a value comprised between the theoretical minimum temperature TtankCold and the theoretical maximum temperature TtankHot, or to a value equal to one of either the theoretical minimum temperature TtankCold or the theoretical maximum temperature TtankHot.

It should be noted that the theoretical minimum temperature TtankCold and the theoretical maximum temperature TtankHot may be determined using, respectively, an initial temperature TtankColdIni and TtankHotIni.

The initial temperatures TtankColdIni and TtankHotIni can be obtained by calculation via the predictive curves “TPgas_hot” and “TPgas_cold”, each dependent on the pressure Pgas of the gas in the tank 1, as measured by the pressure sensor 4, and on the ambient temperature Tamb outside the tank 1, as measured using the first temperature sensor 5.

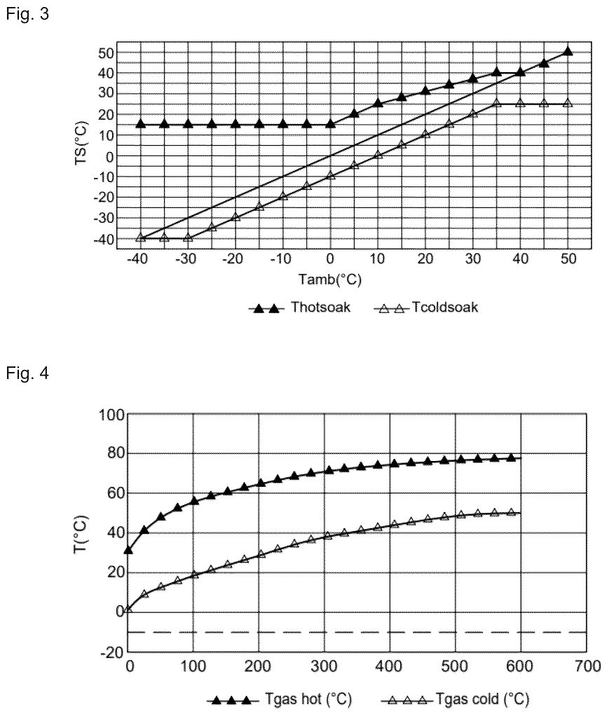

Advantageously, the first initial temperature TtankColdIni and the second initial temperature TtankHotIni can be obtained respectively from a first theoretical curve “TcoldSoak” and a second theoretical curve “ThotSoak”, each giving a variation in the temperature of the gas in a first reference tank as a function of the ambient temperature Tamb. The curves “TcoldSoak” and “ThotSoak” are illustrated in FIG. 3.

On the theoretical curve “TcoldSoak”, the first initial temperature TtankColdIni is comprised within a range of high temperatures having a determined lower limit which is greater than or equal to the ambient temperature Tamb (around 20° C.), and a determined upper limit which corresponds to a fixed maximum temperature, for example equal to 85° C. The second initial temperature TtankHotIni is comprised within a range of low temperatures having a determined upper limit which is less than or equal to the ambient temperature Tamb (around 20° C.), and a determined lower limit which corresponds to a fixed minimum, for example comprised between zero and −40° C.

The first initial temperature TtankColdIni and the second initial temperature TtankHotIni can be determined using the second sensor 7 of the estimation module. In that case, the first initial temperature TtankColdIni and the second initial temperature TtankHotIni are respectively the highest and lowest temperatures measured by the second temperature sensor 7.

It should be noted that in the case of communication between the on-board device 100 and a dispensing station 10, the first initial temperature TtankColdIni or the second initial temperature TtankHotIni that are measured by the second temperature sensor 7 may be used to adapt the cooling temperature or the pressure ramp that are defined by the dispensing station 10.

Advantageously, the predictive curves “TtankCold” and “TtankHot” may each be dependent on an injection temperature Tinj of the gas at the inlet of the tank 1. This injection temperature Tinj may be determined using the third temperature sensor 8.

As a variant, the injection temperature Tinj of the gas at the inlet of the tank 1 may be calculated using the computer 6 and using a function f that is dependent on the temperature Tdisp of the gas and the pressure pdisp of the gas at the dispensing station 10. The function f may also be dependent on the ambient temperature Tamb. This makes it possible to account for exchanges of heat between the tank 1 and the external environment.

In particular, the temperature Tdisp and the pressure pdisp are measured using a temperature sensor 9a and a pressure sensor 9b of the dispensing station 10. Thus, calculating the injection temperature Tinj using the function f requires electronic communication between the computer 6 and the dispensing station 10.

The function f can be written using the following expression [Math 1], where
pdisp is the pressure of the gas in the station, expressed in bar;
Tdisp is the temperature of the gas at the dispensing station 10, expressed in ° C.;
Tamb is the ambient temperature, expressed in ° C.;
ptank is the pressure of the gas in the tank 1, expressed in bar.

$${T}_{i n j} = f ( {T}_{amb} , {T}_{disp} , {p}_{disp} , {p}_{tank} )$$

The function f can be obtained by assuming that the fluid line between the dispensing station 10 and the tank 1 is perfectly insulated, that is to say adiabatic. This assumption means that the specific enthalpy h at the dispensing station 10 can be considered as being equal to the enthalpy of the gas injected into the tank 1.

The specific enthalpy h of the gas at the dispensing station 10 is a function of the pressure pdisp and of the temperature Tdisp of the gas. The specific enthalpy h of the gas injected into the tank 1 is a function of the pressure ptank of the gas in the tank 1 and of the injection temperature Tinj.

The enthalpy equality equation can then be written using the following expression [Math 2], where ptank is the pressure supplied by the pressure sensor 2 situated in the tank 1.

$$h ( {p}_{disp} , {T}_{disp} ) = h ( {p}_{tank} , {T}_{inj} )$$

It is acknowledged that the pressure ptank in the tank 1 can be considered as being uniform. Thus, a single pressure measurement point provides a good representation of the mean pressure in the tank 1.

By applying the reverse calculation to the enthalpy equality equation expressed in [Math 2], the injection temperature Tinj can be deduced using the following expression [Math 3]:

$${T}_{inj} = {h}^{- 1} ( {p}_{t ank} , h ( {p}_{disp} , {T}_{disp} )$$

Advantageously, the predictive curves “TtankCold” and “TtankHot” may each be dependent on the injected mass of gas at the inlet of the tank 1. In order to access this injected mass, the estimation module may advantageously comprise a flowmeter (not illustrated).

This flowmeter is configured to measure the rate of flow \dot{m}inj injected at the inlet of the tank 1. Furthermore, this flowmeter is configured to communicate with the computer 6. Finally, this flowmeter may be located at the inlet of the tank 1.

In a variant, in the case of communication between the on-board device 10 and the dispensing station 100, the computer 6 may receive data relating to the injected mass, this data coming from a flow rate measurement \dot{m}inj performed by the dispensing station 100.

Advantageously, the predictive curves “TtankHot” and “TtankCold” may each be dependent on the geometric parameters of the tank 1 and/or on the geometric parameters of the injector 2 and/or on the thermophysical properties of the gas in the tank 1.

The geometrical parameters of the tank 1 notably include the volume V of the tank 1, the surface area Sw of contact between the gas and the interior wall of the tank 1, the interior diameter Dint of the tank 1, the interior length Lint of the tank 1, the thicknesses elayer, N of each layer N of the tank (layer in contact with the gas, layer in contact with the external medium, intermediate layers).

The geometric parameters of the injector 2 notably include the cross section of the injector 2.

The thermophysical properties of the gas present in the tank 1 notably include the density ρ, the kinematic viscosity μ, the thermal conductivity λ, the isobaric thermal expansion coefficient β, the specific heat capacity cp, the compressibility factor z, the thermal emissivity ε, the specific enthalpy h.

When data relating to certain geometrical parameters of the tank 1 are unknown, a default value can be used. This value will tend towards maximizing the exchanges between the gas and the external environment. Such values are available in standard SAE J2601, but may be selected differently.

Advantageously, the computer 6 is configured to issue alerts aimed at the user or command actions on the part of the dispensing station 10, of the shut-off valve 3 or of any other equipment of the on-board device 100, on the basis of the temperature Tgas approximated by the computer 6.

The alerts or action commands may be issued in the event of overfilling or overheating of the tank 1 during the course of filling, or in the event of critical cold affecting the tank 1 following emptying.

Critical cold means a temperature of the gas in the tank 1 that is below a certain limit fixed at −40° C. in accordance with the recommendations of Standard SAE J2601.

Overfilling occurs when the density ρ(Pgas, Tgas) of the gas in the tank 1 exceeds the density ρ(PNWP, 15° C.) of said gas at the nominal working pressure (PNWP) and at a temperature of 15° C. Generally, the ratio of these two densities, known as the state of charge (SOC), is compared in order to determine whether overfilling has occurred.

Overfilling is therefore indicated by an SOC greater than 1, which can be expressed using the following expression [Math 4]:

$$SOC = \frac{ρ ( {P}_{gas} , {T}_{gas} )}{ρ ( {P}_{NWP} , 15 ° C . )} > 1$$

The actions commanded of the dispensing station 10 in the event of overfilling or overheating of the tank 1 may comprise halting the filling via a valve of the dispensing station 10. The actions commanded of the shut-off valve 3 in the event of overfilling or overheating of the tank 1 may comprise a closure of this shut-off valve 3. Finally, when the temperature of the tank 1 approaches critical cold following a continuous-emptying action, the computer 6 may command closure of an outlet valve (not illustrated) of the tank 1.

In the event of overfilling of the tank 1 or in the event of emptying or steady-state operation leading to critical cold in the tank 1, the computer 6 approximates the temperature Tgas of the gas in the tank 1 to the value of the theoretical minimum temperature TtankCold.

When the second temperature sensor 7 is provided in the tank 1, the computer 6 approximates the temperature Tgas of the gas in the tank 1 to the minimum of the temperature measured by the second temperature sensor 7 and the theoretical minimum temperature TtankCold.

In the event of overheating of the tank 1, the computer 6 approximates the temperature Tgas of the gas in the tank 1 to the theoretical maximum temperature TtankHot. When the second temperature sensor 7 is provided in the tank 1, the computer 6 approximates the temperature Tgas of the gas in the tank 1 to the maximum of the temperature measured by this second temperature sensor 7 and the theoretical maximum temperature TtankHot.

In both of the above cases, the computer 6 is configured to compare the initial temperature TtankColdIni, TtankHotIni of the gas in the tank 1 with that measured using the second temperature sensor 7. A difference greater than a certain threshold between the two temperatures may indicate a significant deviation in the measurement provided by the second temperature sensor 7 located in the tank 1.

It should be noted that in cases in which the injection temperature Tinj is estimated using data supplied by the dispensing station 10, a difference greater than a certain threshold between the initial temperature TtankColdIni, TtankHotIni of the gas in the tank 1 and the measurement supplied by the second temperature sensor 7 may indicate a lack of accuracy in the estimate of the injection temperature Tinj supplied by the dispensing station 10.

When a significant deviation on the measurement supplied by the second temperature sensor 7 situated in the tank 1 is observed, the on-board device 100, and notably the computer 6, may command the dispensing station 10 to switch to a communication-free filling mode, notably for the purpose of interrupting the transmission of inaccurate values from the computer 6 to the dispensing station 10. In addition, the computer 6 may alert the user to the need to proceed with diagnostics and/or maintenance of the second temperature sensor 7.

Likewise, when a lack of accuracy is revealed in the estimate of the injection temperature Tinj supplied by the dispensing station 10, the on-board device 100, and notably the computer 6, may command the dispensing station 10 to switch to a communication-free filling mode, notably for the purpose of interrupting the transmission of inaccurate values from the dispensing station 10 to the computer 6.

In order to estimate the temperature of the gas in the tank 1 of the storage device 100 described above, the invention proposes a method 200 described below.

The method 200 comprises a step S1 of measuring the pressure Pgas of the gas in the tank 1. This step S1 is executed by the first pressure sensor 4.

The method 200 comprises a step S2 of measuring the ambient temperature Tamb outside the tank 1. This step S2 is executed by the first temperature sensor 5.

The method 200 comprises a step S3 of determination, by the computer 6, of a theoretical minimum temperature TtankCold and of a theoretical maximum temperature TtankHot of the gas in the tank 1. This step S3 therefore comprises two calculation operations S3a, S3b leading respectively to the theoretical maximum temperature TtankHot and to the theoretical minimum temperature TtankCold of the gas in the tank 1.

The calculation operations S3a, S3b may be carried out independently, with no link between them. Thus, the calculation operations S3a, S3b can be performed in parallel.

Moreover, the method 200 comprises a step S4 of approximation, by the computer 6, of the temperature Tgas of the gas. This is approximated either to a value comprised between the theoretical minimum temperature TtankCold and the theoretical maximum temperature TtankHot or to a value equal to the theoretical minimum temperature TtankCold or the theoretical maximum temperature TtankHot.

Advantageously, the method 200 may comprise a step S5 of determining the first initial temperature TtankColdIni and the second initial temperature TtankHotIni. These initial temperatures TtankColdIni, TtankHotIni respectively represent the starting conditions of the first predictive curve “TtankHot” and of the second predictive curve “TtankCold”.

During the course of step S5, the first initial temperature TtankColdIni and the second initial temperature TtankHotIni may be determined by calculation or by measurement, as seen hereinabove. As a variant, the first initial temperature TtankColdIni and the second initial temperature TtankHotIni may be temperatures obtained during a previous cycle of steps S1-S4 of the method 200.

In this variant of step S5, the first initial temperature TtankColdIni and the second initial temperature TtankHotIni are respectively equal to the highest and lowest temperatures estimated during the course of a previous cycle of steps S1-S4 of the method 200.

Advantageously, the method 200 comprises a step S6 of acquisition, by the computer 6, of data relating to geometric parameters of the tank 1 and/or geometric parameters of the injector 2. Data relating to thermophysical properties of the gas in the tank 1 may also be acquired during step S6.

The geometric parameters of the tank 1 and/or of the injector 2, just like the thermophysical properties of the gas in the tank 1 may be taken into consideration in the modelling of the predictive curves “TtankHot” and “TtankCold”.

When the tank 1 is in the process of being filled from a dispensing station 10, the predictive curves “TtankHot” and “TtankCold” may each be dependent also on the injection temperature Tinj. Hence, advantageously, the method 200 may comprise a step S7 of determining the injection temperature Tinj of the gas entering the tank 1.

The step S7 may comprise a first operation S7-1 of calculating the injection temperature Tinj using a function that is dependent on: i) the ambient temperature Tamb measured outside the tank 1, ii) the gas temperature Tdisp measured at the dispensing station, and iii) the gas pressure Pdisp measured at the dispensing station 10.

As a variant or in addition to the first operation S7-1, the step S7 of determining the injection temperature Tinj of the gas entering the tank 1 may comprise a second operation S7-2 of measuring the injection temperature Tinj of the gas using the third temperature sensor 8.

The injection temperature Tinj taken into consideration in, respectively, the first predictive curve “TtankHot” and the second predictive curve “TtankCold” is the highest and, respectively, the lowest, of the temperatures obtained, respectively, during the course of the first, calculation, operation S7-1 and during the course of the second, measurement, operation S7-2.

Advantageously, the first predictive curve “TtankHot” and the second predictive curve “TtankCold” are obtained from a physical model that simulates the filling or emptying of a second reference tank. This physical model is based on a system of equations comprising at least one of: i) an internal energy balance equation applied to the gas in the tank 1, ii) a mass balance equation applied to the gas in the tank 1, iii) an energy conservation equation relating to a wall of the tank 1, iv) an equation of continuity of heat flux between the gas in the tank 1 and the wall of the tank 1, v) an equation of continuity of heat flux between the wall of the tank 1 and the ambient air, and vi) a flow rate equation connecting a mass flow rate of the dispensing station 10 to a pressure difference between the filling device (10) and the tank 1, vii) an equation of state for the gas.

These equations are described below.

Assuming that the volume of gas in the tank 1 represents a single volume to which the principles of conservation of mass and conservation of energy are applied, the conservation of mass equation can be written using the following expression [Math 5], where:
M is the mass in the tank, expressed in kg; and
\dot{m}inj is the mass flow rate of the mass injected into the tank, expressed in kg/s.

$$\frac{d m}{dt} = {\dot{m}}_{inj}$$

The conservation of energy equation can be written using the following expression [Math 6], where:
cp is the specific heat capacity of the gas, expressed in J/K/kg;
T is the temperature of the gas, expressed in K;
t is the time, expressed in s;
V is the volume of the tank, expressed in m3;
β is the isobaric expansion coefficient for the gas, expressed in 1/K;
p is the pressure of the gas, expressed in Pa;
Sw is the surface area of the interior wall of the tank 1, expressed in m2;
Tg,w is the mean temperature of the interior wall of the tank 1, expressed in K;
h is the enthalpy of the gas, expressed in J/kg;
Tinj is the temperature of the injected gas, expressed in K;
uinj is the velocity of the injected gas, expressed in m/s;
kg is the heat exchange coefficient for exchanges of heat between the gas and the interior wall of the tank 1, expressed in W/m2/K. It is calculated using a correlation that employs system quantities that already exist.

$$m {c}_{p} \frac{dT}{dt} = V β T \frac{dp}{dt} + {k}_{g} {S}_{w} ( {T}_{g , w} - T ) + {\dot{m}}_{inj} ( h ( p , {T}_{inj} ) + \frac{{u}_{inj}^{2}}{2} - h ( p , T ) )$$

The velocity of the injected gas can be deduced from the mass flow rate of the injected mass. This velocity is expressed using the following expression [Math 7], where:
ρinj=ρ(p,Tinj) is the density of the gas at the injector 2, expressed in kg/m3; and
Sinj is the outlet cross section of the injector 2, expressed in m2.

$${u}_{inj} = \frac{{\dot{m}}_{inj}}{{ρ}_{inj} {S}_{inj}}$$

The system of equations ([Math 5], [Math 6]) is supplemented by the equation of state for the gas, presented here via the following formula [Math 8], which accounts for a real gas by using the compressibility factor Z(p,T), where:
M is the molar mass of the gas, expressed in kg/mol;
R is the perfect gas constant, expressed in J/mol/K.

$$pV = \frac{m}{M} RZ ( p , T ) T$$

The heat transfer in the walls is modelled using an energy conservation balance applied to an elementary mesh cell of the wall, in a direction radial to the main axis of the tank 1. This energy balance can be expressed using the following expression [Math 9], where:
ρw is the density, expressed in kg/m3;
cp,w is the specific heat capacity, expressed in J/K/kg;
λw is the thermal conductivity of the material of the mesh cell on which the energy balance is performed, expressed in W/m/K;
r is the distance to the main axis of the tank 1, expressed in m;
Tw is the temperature at the centre of the mesh cell, expressed in K.

$${ρ}_{w} {c}_{p , w} \frac{\partial {T}_{w}}{\partial t} = \frac{{λ}_{w}}{{r}_{w}} \frac{\partial }{\partial r} ( r \frac{\partial {T}_{w}}{\partial r} )$$

The system is closed by the boundary conditions that express the continuity of heat flux of each end of the wall material considered.

On the exterior wall of the tank 1 this condition can be written using the following expression [Math 10], where
ka is the heat exchange coefficient for exchanges of heat between the exterior wall of the tank 1 and the surrounding environment, expressed in W/m2/K. This coefficient is calculated using a correlation that employs system quantities that already exist;
Sw,ext is the surface area of the exterior wall of the tank 1, expressed in m2;
Tw,Rext is the mean temperature of the exterior wall of the tank 1, expressed in K;
Rext is the exterior radius of the tank 1, expressed in m;
∈ (dimensionless) is the thermal emissivity of the exterior wall;
σ is the Stefan-Boltzmann constant, expressed in W/m2/K4;
Tamb is the ambient temperature around the tank 1, expressed in K.

$$- {λ}_{w} {S}_{w , ext} \frac{\partial {T}_{w}}{\partial r} {\vert}_{r = {R}_{ext}} = {k}_{a} {S}_{w , ext} ( {T}_{w , {R}_{ext}} - {T}_{amb} ) + ∈ σ {S}_{w , ext} ( {T}_{w , {R}_{ext}}^{4} - {T}_{amb}^{4} )$$

In the context of hydrogen-powered mobility, the tank 1 is generally made up of two layers: a first layer (known as the liner) making up the wall of the tank 1 that is in contact with the gas, and a second layer (known as the composite) bonded to the first layer and constituting the rest of the wall.

On the internal wall of the tank 1, therefore on the liner side, the boundary conditions can be written in accordance with the following formula [Math 11], where Rint is the internal radius of the tank, expressed in m.

$${λ}_{liner} \frac{\partial {T}_{liner}}{\partial r} {\vert}_{r = {R}_{i n t}} = {k}_{g} ( {T}_{liner , i n t} - {T}_{g} )$$

At the interface between the first layer (the liner) and the second layer (the composite), the thermal flux continuity can also be expressed using the following relationship [Math 12]:

$${λ}_{liner} \frac{\partial {T}_{liner}}{\partial r} {\vert}_{r = {R}_{i n t} + {e}_{liner}} = {λ}_{composite} \frac{\partial {T}_{composite}}{\partial r} {\vert}_{r = {R}_{i n t} + {e}_{liner}}$$

Likewise, the equality of temperatures at the interface between the first layer (the liner) and the second layer (the composite) can be expressed using the following relationship [Math 13]:

$${T}_{liner , r = {R}_{i n t} + {e}_{liner}} = {T}_{composite , r = {R}_{i n t} + {e}_{liner}} .$$

What is claimed is:

1. An on-board device (100) for storing pressurized gas, comprising a tank (1), a first sensor (4) configured to measure the pressure (Pgas) of the gas in the tank (1), a first sensor (5) configured to measure the ambient temperature (Tamb), a computer (6) comprising an electronic system provided with a microprocessor for acquiring and processing data, the computer (6) being configured to: i) receive and process measurements from the sensors (4, 5) and ii) calculate a theoretical minimum temperature (TtankCold) and a theoretical maximum temperature (TtankHot) of the gas in the tank (1) on the basis of the measurements from the sensors (4, 5) and by using at least one predefined predictive model, the computer (6) also being configured to approximate the temperature (Tgas) of the gas in the tank (1) to a value comprised between the theoretical minimum temperature (TtankCold) and the theoretical maximum temperature (TtankHot) or to a value equal to one of either the theoretical minimum temperature (TtankCold) or the theoretical maximum temperature (TtankHot).

2. The device (100) according to claim 1, wherein the theoretical minimum temperature (TtankCold) and the theoretical maximum temperature (TtankHot) are respectively determined with the aid of a first predictive curve “TPgas_hot” and a second predictive curve “TPgas_cold”, each dependent on the pressure (Pgas) of the gas in the tank (1), as measured by the first pressure sensor (4), and on the ambient temperature (Tamb) outside the tank (1), as measured by the first temperature sensor (5).

3. The device (100) according to claim 2, further comprising a second sensor (7) for measuring the temperature of the gas in the tank (1), the second sensor (7) being configured to provide a first initial temperature (TtankColdIni) and a second initial temperature (TtankHotIni) respectively representing the starting conditions of the first predictive curve “TPgas_hot” and the starting conditions of the second predictive curve “TPgas_cold”, the first initial temperature (TtankColdIni) and the second initial temperature (TtankHotIni) being respectively equal to the highest and lowest temperatures measured by the second temperature sensor (7).

4. The device (100) according to claim 1, wherein the gas temperature (Tgas) determined by the computer (6) is equal to:
the theoretical minimum temperature (TtankCold), in the event of overfilling of the tank (1), i.e. when the state of charge of the tank (1) is greater than 1, or
the theoretical maximum temperature (TtankHot), in the event of overheating, i.e. when the theoretical maximum temperature (TtankHot) reaches a predetermined critical threshold.

5. The device (100) according to claim 3, wherein the gas temperature (Tgas) determined by the computer (6) is equal to:
the lowest of i) the temperature measured by the second temperature sensor (7) and ii) the theoretical minimum temperature (TtankCold), in the event of overfilling of the tank (1), i.e. when the state of charge of the tank (1) is greater than 1, or
the highest of i) the temperature measured by the second temperature sensor (7) and ii) the theoretical maximum temperature (TtankHot), in the event of overheating of the tank (1), i.e. when a predefined maximum temperature threshold is reached.

6. The device (100) according to claim 2, wherein the computer (6) is configured to calculate a first injection temperature (Tinj_1) at the inlet of the tank (1), from a temperature (Tdisp) and a pressure (Pdisp) of the gas, both measured at the dispensing station (10), the first predictive curve “TPgas_hot” and the second predictive curve “TPgas_cold” each also being dependent on the first injection temperature (Tinj_1).

7. The device (100) according to claim 1, comprising an injector (2) connecting the tank (1) to a dispensing station (10), the injector (2) being provided with a third temperature sensor (8) configured to measure a second injection temperature (Tinj_2) of the gas at the inlet of the tank (1), and communicate said second injection temperature (Tinj_2) to the computer (6), the first predictive curve “TPgas_hot” and the second predictive curve “TPgas_cold” each also being dependent on the second injection temperature (Tinj_2).

8. A method (200) for real-time estimation of the temperature (Tgas) of a gas in an on-board device (100) for storing pressurized gas, the device (100) comprising a tank (1), a first pressure sensor (4), a first temperature sensor (5), a computer (6) comprising an electronic system equipped with a microprocessor for acquiring and processing data, the method (200) comprising a step (S1) of measuring the pressure (Pgas) of the gas in the tank (1), using the pressure sensor (4), a step (S2) of measuring the ambient temperature (Tamb) outside the tank (1), using the first temperature sensor (5), a step (S3) of determining, on the basis of the measurements from the sensors (4, 5) and by using at least one predefined predictive model, a theoretical minimum temperature (TtankCold) and a theoretical maximum temperature (TtankHot) of the gas in the tank (1), and a step (S4) of approximating the temperature (Tgas) of the gas in the tank (1) to a value comprised between the theoretical minimum temperature (TtankCold) and the theoretical maximum temperature (TtankHot), or to a value equal to one of either the theoretical minimum temperature (TtankCold) or the theoretical maximum temperature (TtankHot), the steps (S3, S4) being executed by the computer (6).

9. The method (200) according to claim 8, wherein the theoretical minimum temperature (TtankCold) and the theoretical maximum temperature (TtankHot) are respectively calculated with the aid of a first predictive curve “TPgas_hot” and a second predictive curve “TPgas_cold”, each dependent on the pressure (Pgas) of the gas in the tank (1), as measured by the pressure sensor (4), and on the ambient temperature (Tamb) outside the tank (1), as measured by the first temperature sensor (5).

10. The method (200) according to claim 9, comprising a step (S5) of determining a first initial temperature (TtankColdIni) and a second initial temperature (TtankHotIni) respectively representing the starting conditions of the first predictive curve “TPgas_hot” and the starting conditions of the second predictive curve “TPgas_cold”, the first initial temperature (TtankColdIni) corresponding to a first state of the tank (1) that is considered to have been recently filled to a first initial density, the second initial temperature (TtankHotIni) corresponding to a second state of the tank (1) which is considered to have been recently drawn from down to a second initial density.

11. The method (200) according to claim 10, wherein the first initial temperature (TtankColdIni) and the second initial temperature (TtankHotIni) are obtained respectively from a first theoretical curve “ThotSoak” and a second theoretical curve “TcoldSoak”, each giving a variation in the temperature of the gas in a first reference tank as a function of the ambient temperature (Tamb), the first theoretical curve “ThotSoak” relating to the first reference tank in the process of being filled, the second theoretical curve “TcoldSoak” relating to the second reference tank in the process of being emptied.

12. The method (200) according to claim 10, wherein the first initial temperature (TtankColdIni) and the second initial temperature (TtankHotIni) are measured using a second temperature sensor (7) disposed in the tank (1), the first initial temperature (TtankColdIni) and the second initial temperature (TtankHotIni) being respectively equal to the highest and lowest temperatures measured by the second temperature sensor (7).

13. The method (200) according to claim 10, wherein the first initial temperature (TtankColdIni) and the second initial temperature (TtankHotIni) are temperatures obtained during the course of a previous cycle of steps (S1, S2, S3, S4) of the method (200), the first initial temperature (TtankColdIni) and the second initial temperature (TtankHotIni) being respectively equal to the highest and lowest temperatures estimated during the course of the previous cycle of steps (S1, S2, S3, S4) of the method (200).

14. The method (200) according to claim 8, comprising a step (S6) of acquisition, by the computer (6), of data relating to geometric parameters of the tank (1), and of data relating to thermophysical properties of the gas present in the tank (1), the predictive curves “TPgas_hot” and “TPgas_cold” being further dependent on each of said geometric parameters and of said thermophysical properties of the gas.

15. The method (200) according to claim 8, comprising a step (S7) of determining at least one injection temperature (Tinj) of the gas entering the tank (1), the predictive curves “TPgas_hot” and “TPgas_cold” each being further dependent on the injection temperature (Tinj).

16. A method for commanding a halt in the filling of an on-board device (100) for storing pressurized gas, the device (100) comprising a tank (1), a sensor (4) for measuring the pressure (Pgas) of the gas in the tank (1), a first sensor (5) for measuring the ambient temperature (Tamb), a computer (6) comprising an electronic system provided with a microprocessor for acquiring and processing data, the computer (6) being configured to calculate a theoretical minimum temperature (TtankCold) and a theoretical maximum temperature (TtankHot) of the gas in the tank (1) on the basis of the measurements from the sensors (4, 5) and by using at least one predefined predictive model, the computer (6) also being configured to approximate the temperature (Tgas) of the gas in the tank (1) to a value comprised between the theoretical minimum temperature (TtankCold) and the theoretical maximum temperature (TtankHot) or to a value equal to one of either the theoretical minimum temperature (TtankCold) or the theoretical maximum temperature (TtankHot), the method comprising the step of issuing a command to halt the filling of the tank (1) on the basis of the temperature (Tgas) approximated by the computer (6).
